(19) United States
(12) Patent Application Publication
(10) Pub. No.: US 2011/0031158 A1
(43) Pub. Date: Feb. 10, 2011

(54) Ergonomically Designed Tray

(76) Inventor: Phyllis King, Mequone, WI (US)

Correspondence Address: Phyllis King, 12052 Maryhill Court, Mequon, WI, 53092, US

(21) Appl. No.: 12/536,720

(22) Filed: Aug. 6, 2009

(51) Int. Cl. B65D 1/34; B23P 19/04; B65D 25/28

(52) U.S. Cl. 206/557; 29/700; 220/752

(57) ABSTRACT

The present invention is a serving tray with an ergonomically designed handle which can be selectively attached and detached to the bottom of a serving tray. The handle interlock system improves the stability of the tray lessening the risk of accident due to unbalanced loads or load instability. The orientation of the handle and the handling posture of the tray engage two strong elbow flexor muscles and increase muscle strength. In addition, the handling posture reduces the risk of tendonitis and carpal tunnel syndrome which results from wrist flexing and applied force associated with traditional tray handling and carrying posture.

### FIELD OF INVENTION

The present invention relates to the field of restaurant trays and more particularly to an ergonomically designed tray.

### BRIEF DESCRIPTION OF THE DRAWINGS

FIG. 1 shows a side perspective view of an exemplary embodiment of an assembled ergonomically designed tray in use.

FIG. 2 shows a bottom perspective view of an exemplary embodiment of an ergonomically designed tray having a track component.

FIG. 3 shows a bottom perspective view of an exemplary embodiment of an assembled ergonomically designed tray.

FIG. 4 shows a side perspective view of an exemplary embodiment of an assembled ergonomically designed tray.

FIG. 5 shows an exploded view of an exemplary embodiment of a handle for an ergonomically designed tray.

FIG. 6 shows an exploded view of a second exemplary embodiment of a handle for an ergonomically designed tray.

### GLOSSARY

As used herein, the term “ergonomically designed” means a component which has been designed to maximize productivity by minimizing user fatigue, discomfort and injuries.

As used herein, the term “handle interlock system” means components which provide secure mounting capability for a handle to a tray.

As used herein, the term “tray” means a flat, shallow container or receptacle used for carrying, serving, holding or displaying food, beverages, dishes, or other items. A tray may have slightly raised or tapered edges.

As used herein, the term “selectively attachable” means one or one components which can be securely attached to a component and removed without requiring alteration to the selectively attachable component or to the one or more components to which it is attached.

### BACKGROUND

The U.S. Occupational Safety and Health Administration (OSHA) has recognized the importance of ergonomics in the workplace. In 1999, OSHA issued a Proposed Ergonomics Standard that would apply to manufacturing facilities as well as “manual handling” operations (e.g., office services employees, domestic service workers, bartenders and wait staff, sales workers) and any industry in which one employee has experienced a sign or symptom of a musculoskeletal disorder (i.e., disorders that affect the body's muscles, joints, tendons, ligaments and nerves).

In 2007, OSHA published Ergonomics Guidelines for Manual Material Handling as part of its four-pronged strategy to reduce ergonomic injuries. In addition, OSHA will develop industry or task specific guidelines for a number of industries based on current incidence rates available information about effective and feasible solutions. OSHA has already released numerous industry specific ergonomics guidelines (e.g. guidelines for retail grocery) which specially address repetitive strain injuries and other musculoskeletal disorders.

Although OSHA has not currently formulated standards specific to the restaurant industry, it is expected to do so. The restaurant industry currently employs 2.3 million waiters, waitresses and food servers, each of who is expected to carry trays laden with food and/or beverages. Repetitive strain injuries, such as tendonitis and carpal tunnel syndrome are common among waiters and waitresses and can be very painful and take a long time to heal. Injuries and accidents can also occur as a result of instability of a tray or unbalanced loads.

Waiters and waitresses typically carry a tray using one hand by balancing the tray on their upright palm. Carrying a tray like this is awkward and puts a substantial amount of strain and pressure on the server's wrist. Extreme wrist extension with applied force is a primary risk factor for carpal tunnel syndrome.

There are examples of serving trays known in the art which have attempted to improve upon the standard serving tray and/or the method of carrying a serving tray. For example U.S. Pat. No. 5,711,595 (Gerbe '595). Gerbe '595 teaches an illuminated serving tray which has a flashlight-like protrusion that acts as a source of light, as well as a convenient handle for the user to carry and maneuver the tray with. Although the tray taught by Gerbe '595 includes a handle, the handle is not removable from the tray.

U.S. Pat. No. 2,723,068 (Ettwein '068) is another example of an improved serving tray and way of carrying a serving tray. Ettwein '068 teaches a serving tray or dish holder with twin collapsible handle members on the underside of the tray. When in the erect position, both members are simultaneously grasped and are substantially rigid and non-tiltable so that the tray is securely supported with one hand by the handle members. When the members are in the collapsed position, the trays may be stacked.

It is desirable to have a serving tray that is ergonomically designed to comply with OSHA's ergonomic guidelines.

It is further desirable to have an ergonomic tray which can be stacked and efficiently stored.

It is further desirable to have an ergonomic tray which can be easily cleaned.

### SUMMARY OF THE INVENTION

The present invention is a serving tray with an ergonomically designed handle to improve comfort and efficiency in handling for the user while preventing muscle strain and repetitive injuries. The handle may be selectively attached and detached to the bottom of the serving tray using the handle interlock system. The handle interlock system improves the stability of the tray lessening the risk of accident due to unbalanced loads or load instability.

The orientation of the handle and the handling posture of the tray engage two strong elbow flexor muscles, the biceps brachii and the brachioradialis muscles, and increase muscle strength. In addition, the handling posture reduces the risk of tendonitis and carpal tunnel syndrome which results from wrist flexing and applied force associated with traditional tray handling and carrying posture.

### DETAILED DESCRIPTION OF INVENTION

For the purpose of promoting an understanding of the present invention, references are made in the text to exemplary embodiments of a tray with an ergonomically designed handle, only some of which are described herein. It should be understood that no limitations on the scope of the invention are intended by describing these exemplary embodiments. One of ordinary skill in the art will readily appreciate that alternate but functionally equivalent sizes, shapes and materials may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale; instead emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change in the basic function to which it is related.

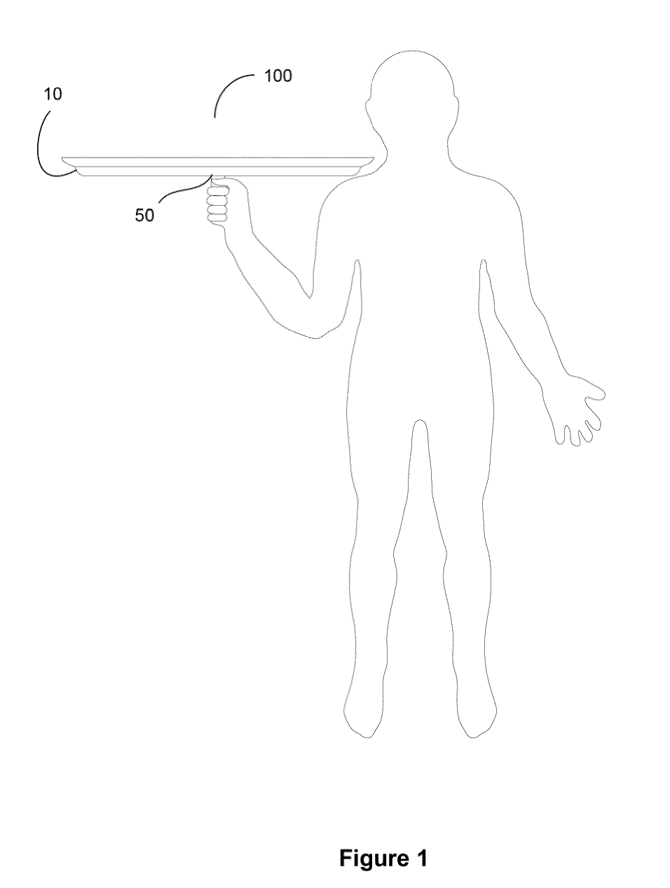

FIG. 1 shows a side perspective view of an exemplary embodiment of ergonomically designed tray 100 in use. Visible are tray 10 and ergonomic handle 50. The user holds onto ergonomically designed tray 100 by placing his or her palm on handle 50 and wrapping his or her fingers around handle 50.

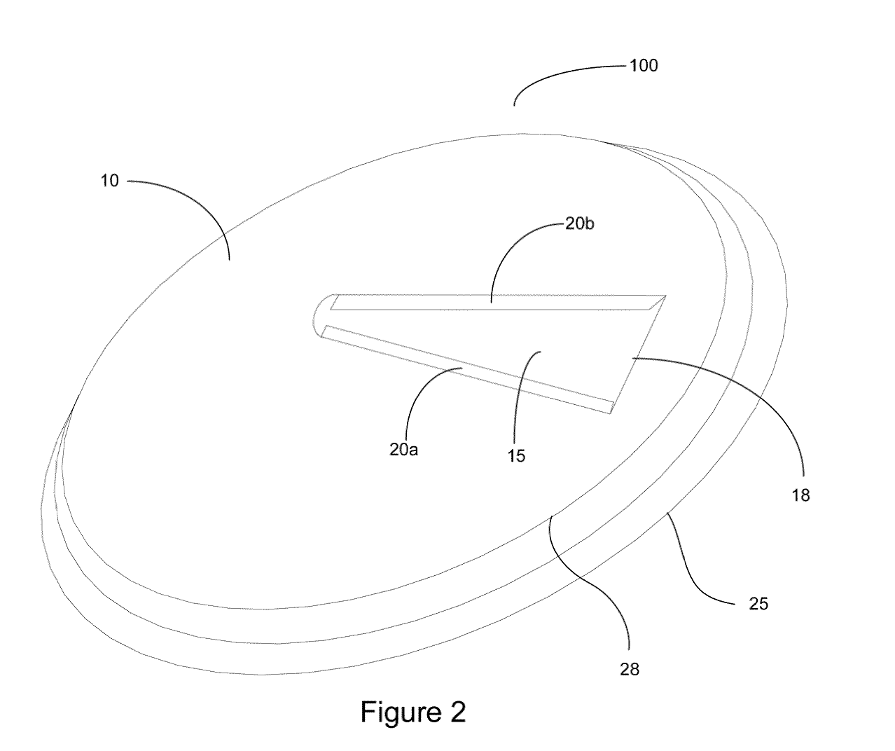

FIG. 2 shows a bottom perspective view of an exemplary embodiment of ergonomically designed tray 100 without handle 50. Visible is track component 15 which provides a means for attaching handle 50 to tray 10. In the embodiment shown, base 18 of track component 15 is not orientated along the bottom edge of serving tray 10 but rather base 18 is located at a distance from the bottom edge of serving tray 10.

In the embodiment shown, rim 25 of tray 10 is larger than bottom 28 of tray 10 which allows tray 10 to be efficiently stacked with trays of similar dimensions when handle 50 is not attached to tray 10.

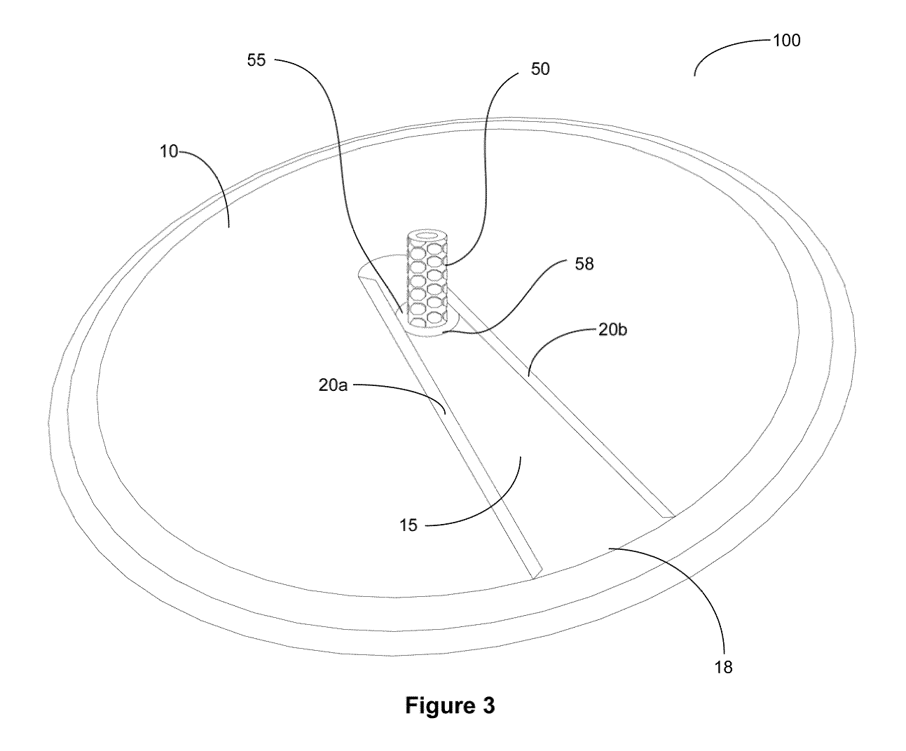

FIG. 3 shows a bottom perspective view of an exemplary embodiment of ergonomically designed tray 100 which consists of tray 10 and handle 50. In the embodiment shown, tray 10 is a standard large tray with bottom 28 having a diameter of 22 inches and rim 25 having a diameter of 27 inches. In other embodiments, serving tray 10 has a diameter between 11 inches and 30 inches.

Attached to the bottom of serving tray 10 is track component 15. In the embodiment shown, track component 15 is orientated along the bottom edge of tray 10 and is made of aluminum and has a triangular shape with base 18 measuring 5 inches. In other embodiments, track component 15 is made of plastic, fiberglass, wood, layers of epoxy another type of metal, or another material, and/or is of another shape and size.

In the embodiment shown, track component 15 has rails 20a, 20b on the two long sides of track component 15. Rails 20a, 20b are contoured to receive handle 50 having interlocking component 55. In the embodiment shown, rails 20a, 20b are ⅝ inches high, have a 2/8 inch groove, and are 5 inches apart at base 18. Rails 20a, 20b taper inward from base 18 of track component 15. In other embodiments, rails 20a, 20b have varying dimensions and/or are of a different design which corresponds to the size and shape of interlocking component 55.

Handle 50 is attached to interlocking component 55 and is selectively attachable to tray 10. Edge 58 of interlocking component is of a height that fits between the grooves of rails 20a, 20b on track component 15. Interlocking component 55 and handle 50 are slid in the groove of rails 20a, 20b toward the center of serving tray 10 until wedged securely between rails 20a, 20b. Handle 50 and interlocking component 55 may be selectively detached from tray 10 by moving interlocking component 55 and handle 50 out toward base 18. In the embodiment shown, interlocking component 55 with handle 50 is secured in the middle of serving tray 10.

In the embodiment shown, interlocking component 55 is circular in shape and is made of metal, with edge 58 having a height that is slightly less than ⅝ inches, the height of rails 20a, 20b. In addition, the diameter of interlocking component 55 is greater than the diameter of handle 50 so that it protrudes beyond handle 50 which prevents handle 50 from being damaged and allows interlocking component 55 to be secured between rails 20a, 20b.

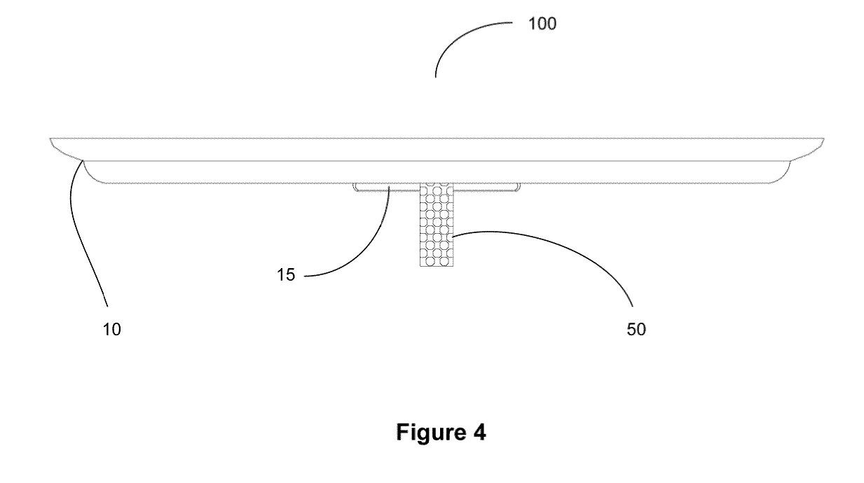

FIG. 4 shows a side perspective view of an exemplary embodiment of an assembled ergonomically designed tray 100. Visible are tray 10, handle 50 and track component 15.

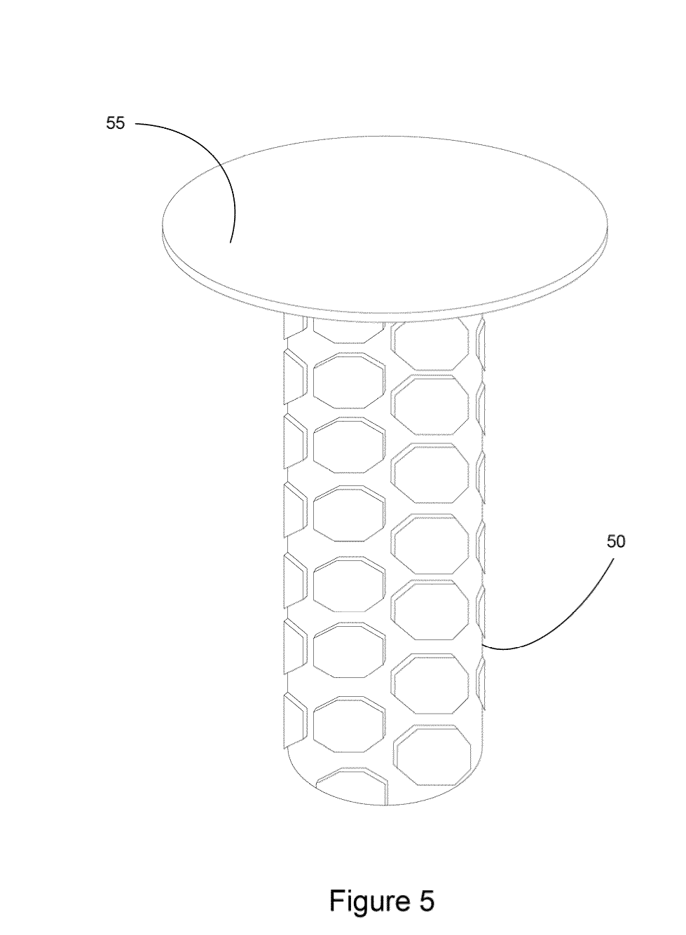

FIG. 5 shows an exploded view of an exemplary embodiment of handle 50 for ergonomically designed tray 100. In the embodiment shown, interlocking component 55 is circular in shape and has a diameter of 2 inches. In other embodiments, interlocking component 55 has a diameter of between 1¼ inches to 3½ inches and/or is of a different shape with varying dimensions. The diameter of interlocking component 55 will be larger than the diameter or dimensions of handle 50 and will correspond to the distance between rails 20a, 20b.

In the embodiment shown, interlocking component 55 is metal. In other embodiments, interlocking component 55 may be made of a material other than metal, such as plastic or any other material which has an edge that is capable of being slid between rails 20a, 20b and which is strong enough to be secured between rails 20a, 20b and to support serving tray 10.

In the embodiment shown, handle 50 is cylindrical and ergonomically designed having a size and shape to fit any user providing comfort to the user and lessening the strain and fatigue of the user's wrist. In the embodiment shown, handle 50 has a gripping surface which provides the user with a comfortable grip. In addition, handle 50 is easy to clean and maintain (e.g., can be cleaned in a dishwasher).

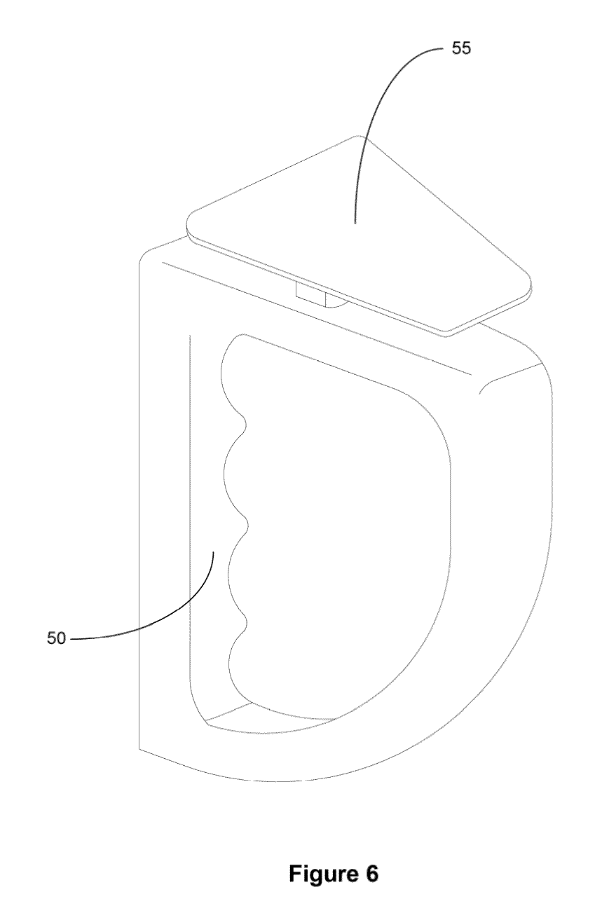

FIG. 6 shows an exploded view of a second exemplary embodiment of handle 50 for ergonomically designed tray 100. In the embodiment shown, interlocking component 55 is an isosceles trapezoid and is made of metal. In other embodiments, interlocking component 55 is circular in shape or is of any other shape capable of being wedged between rails 20a, 20b in order to secure handle 50. In other embodiments, interlocking component 55 may be made of a material other than metal, such as plastic or any other material which has an edge that is capable of being slid between rails 20a, 20b and which is strong enough to be secured between rails 20a, 20b and to support serving tray 10.

In the embodiment shown, handle 50 is D-shaped and is ergonomically designed having a size and shape to fit any user providing comfort to the user and lessening the strain and fatigue of the user's wrist. In the embodiment shown, the straight portion of handle 50 contains impressions for the four fingers which provide additional support and comfort to the user's hand and wrist. In addition, handle 50 is easy to clean and maintain (e.g., can be cleaned in a dishwasher).

What is claimed is:

1. An ergonomically designed tray comprised of:
a tray;
a handle interlock system; and
a handle.

2. The ergonomically designed tray of claim 1 wherein said handle interlock system is comprised of a track component secured to said tray and an interlocking component secured to said handle.

3. The ergonomically designed tray of claim 2 wherein said interlocking component is circular in shape.

4. The ergonomically designed tray of claim 2 wherein said interlocking component is in the shape of an isosceles trapezoid.

5. The ergonomically designed tray of claim 2 wherein said track component further includes a plurality of rails.

6. The ergonomically designed tray of claim 5 wherein said plurality of rails are diagonal and are furthest apart nearest the edge of said tray.

7. The ergonomically designed tray of claim 5 wherein said plurality of rails are 5 inches apart nearest said edge of said tray.

8. The ergonomically designed tray of claim 5 wherein said plurality of rails have a height of ⅝ inches high and a groove with a depth of 2/8 inch.

9. The ergonomically designed tray of claim 1 wherein said handle has a cylindrical shape.

10. The ergonomically designed tray of claim 1 wherein said handle is D-shaped.

11. The ergonomically designed tray of claim 1 wherein said tray has diameters of 22 inches and 27 inches.

12. A method of assembling an ergonomically designed tray comprised of the steps of:
securing a track component having a plurality of diagonal rails to a tray, said plurality of diagonal rails being furthest apart nearest the edge of said tray;
securing a handle to an interlocking component; and
sliding said interlocking component with said handle between said plurality of diagonal rails away from said edge of said tray until secured between said diagonal plurality of rails.

13. The method of assembling the ergonomically designed tray of claim 12 which further includes dissembling said ergonomically designed tray by sliding said interlocking component with said handle toward said edge of said tray.

14. The method of assembling the ergonomically designed tray of claim 12 wherein said plurality of diagonal rails are 5 inches apart at said edge of said tray.

15. The method of assembling the ergonomically designed tray of claim 12 wherein said plurality of diagonal rails have a height of ⅝ inches high and a groove with a depth of 2/8 inch.

16. The method of assembling the ergonomically designed tray of claim 12 wherein said interlocking component is circular in shape.

17. The method of assembling the ergonomically designed tray of claim 12 wherein said interlocking component is in the shape of an isosceles trapezoid.

18. The method of assembling the ergonomically designed tray of claim 12 wherein said handle has a cylindrical shape.

19. The method of assembling the ergonomically designed tray of claim 12 wherein said handle is D-shaped.

20. The method of assembling the ergonomically designed tray of claim 12 wherein said tray has diameters of 22 inches and 27 inches.
